(19) United States
(12) Patent Application Publication
(10) Pub. No.: US 2015/0095160 A1
(43) Pub. Date: Apr. 2, 2015

(54) METHOD AND SYSTEM FOR PROVIDING ADVERTISING ON MOBILE DEVICES

(71) Applicant: Paschar LLC, San Francisco, CA (US)

(72) Inventor: Peter Ma, San Francisco, CA (US)

(73) Assignee: Paschar LLC, San Francisco, CA (US)

(21) Appl. No.: 14/043,178

(22) Filed: Oct. 1, 2013

(51) Int. Cl. G06Q 30/02

(52) U.S. Cl. CPC G06Q 30/0267
USPC 705/14.64

(57) ABSTRACT

A method of providing advertising on a mobile device having a plurality of applications is provided by executing a set of computer executable advertising instructions stored on the mobile device. The instructions are stored as part of an operating system or a secondary application that can run in the background and are capable of identifying an application executing in the foreground. The instructions are stored separately from the executable code for the applications on which advertising is displayed. As a result, application developers can subscribe to an advertising service that displays advertising on their application interfaces without creating any code.

### FIELD

The present disclosure relates to techniques for providing advertising with mobile device applications, and more specifically, to techniques that reduce or eliminate the need for application developers to provide code for generating advertisements on their applications.

### BACKGROUND

With the advent of mobile devices such as iPhones, iPads, Android Tablets, hybrid tablets, and the iPod Touch, application developers have provided large numbers of applications or “apps” that allow users to perform a wide variety of different tasks. Through wireless internet connections to application servers, mobile device users can search for and download a plethora of applications to their mobile devices. Examples of commercial services that provide such applications on application servers are the Apple “App Store” for Apple mobile devices and “Google Play” for phones running on the Android operating system. Applications allow users to process, receive and transmit an endless array of information in the form of text, images, sounds, animations, and video. While some application developers choose to charge subscription fees for access to their applications, others choose to make the applications free to users and to generate revenue from advertisements presented to users in connection with the applications. This latter business model has become a significant source of revenue for many application developers. However, known advertising techniques suffer from several drawbacks.

One known method of providing advertisements requires application developers to include code for displaying advertisements or advertisement interfaces as part of their application code. Another known method requires an application provider such as Google or Apple to provide a software development kit (SDK) that includes code for generating an advertising interface. The application developer then integrates the SDK into the application code. Both of these known methods require the application developer to create or insert code beyond that required for the application itself in order to display advertising when the application is executed. In addition, when changes are made to the advertising interface, the application developer must revise the code for generating the advertising interface (or replace an old SDK with a new one if an SDK technique is used) and then re-compile and upload the application to the application provider. Thus, a need has arisen for a method and system for providing advertising on mobile devices which reduces the amount of effort required of application developers to include advertisements with their applications.

### BRIEF DESCRIPTION OF THE DRAWINGS

The disclosure will now be described, by way of example, with reference to the accompanying drawings, in which:

FIG. 1 is schematic used to illustrate examples of a system for providing advertising on mobile devices;

FIG. 2 is a front elevational view of a mobile device in a first operative state displaying a first user interface comprising an advertising control interface area and an application interface area;

FIG. 3 is a front elevational view of the mobile device of FIG. 1 in a second operative state displaying a second user interface comprising an advertising control interface area, an application user interface area, and a pop-up menu overlaid on the application user interface area;

FIG. 4 is a front elevational view of the mobile device of FIG. 1 in a third operative state displaying a third user interface comprising an application interface area without an advertising control interface area;

FIG. 5 is a front elevational view of the mobile device of FIG. 1 in a fourth operative state displaying a fourth user interface comprising an expanded advertising interface area;

FIG. 6 is a front elevational view of the mobile device of FIG. 1 in a fifth operative state displaying a fifth user interface comprising a banner ad and an application interface area;

FIG. 7 is a flow chart depicting a method of displaying advertising in an advertising interface view on a mobile device display on top of an application interface view;

FIG. 8 is a flow chart depicting a method of subscribing an application developer to a service for providing advertising in an advertising interface view displayed on top of an application interface view;

FIG. 9 is a flow chart depicting a method of providing advertising content to a system of mobile devices;

FIG. 10 is an exemplary advertising subscription web page used to subscribe an application developer to a mobile device advertising service;

FIG. 11 is an exemplary advertising subscription web page used to depict the input of advertising interface format data by an application developer;

FIG. 12 is an exemplary advertising subscription web page used to generate application metadata for use in providing advertising on a mobile device;

FIG. 13 is an exemplary advertising subscription web page used to display an API key and code for adding the API key to a manifest file used by the Android Operating System;

FIG. 14 is an exemplary data table from an application database used to illustrate the storage of application information in association with application metadata;

FIG. 15 is an exemplary data table from an application database used to illustrate the storage of advertising enablement data and advertising interface format data in association with application metadata; and

FIG. 16 is an exemplary data table from an application database used to illustrate the storage of advertising content in association with application metadata.

### DETAILED DESCRIPTION

The present disclosure relates to user interfaces for mobile devices, including mobile smart devices and mobile smart phones, and more particularly, to techniques for providing advertising on graphical user interfaces (GUIs) for such mobile devices. Examples of such mobile devices include the iPhone, Samsung Galaxy, iPad, Android Tablets, hybrid tablets, and the iPod Touch. In general, such mobile devices are portable, handheld devices that communicate wirelessly with other mobile devices and networks and which include the capability of transmitting, receiving, processing, and displaying digital data.

In certain examples, a set of computer executable advertising interface instructions stored on at least one computer readable storage medium on the mobile device are executed to display an advertising interface view on top of an application interface view created by an application developer. The set of computer executable advertising interface instructions identifies an application from among several stored on the mobile device which is executing in the foreground. If advertising is enabled for the executing foreground application, the mobile device receives advertising content from an advertising server and displays an advertising interface view that includes the advertising content on top of an application interface view. In certain examples, the advertising interface view includes a graphic containing the advertising content, and the graphic consumes only a portion of the mobile device display area such that at least a portion of the application interface view remains visible and controllable (i.e., the user can interact with controls in at least a portion of the display 44 area occupied by the application interface view). In other examples, the advertising interface view comprises an expanded advertising interface that covers all (e.g., a full screen advertisement) or substantially all of the application interface.

An application provider makes applications available for downloading from application server 30 via internet 24. In certain examples, the application provider obtains application metadata from an application developer which is used to authenticate the application and to confirm that it is an application for which advertising is to be selectively enabled by the application developer. In other examples, an advertising services provider generates application metadata which is added to the computer executable application instructions, and the generated application metadata is subsequently used to determine whether the application is one for which advertising is to be provided. In the same or other examples, the application developer selects desired advertising interface formats to be used with the advertising interface view. In preferred examples, the application developer does not have to create any code to provide advertising or an advertising interface view with his or her application.

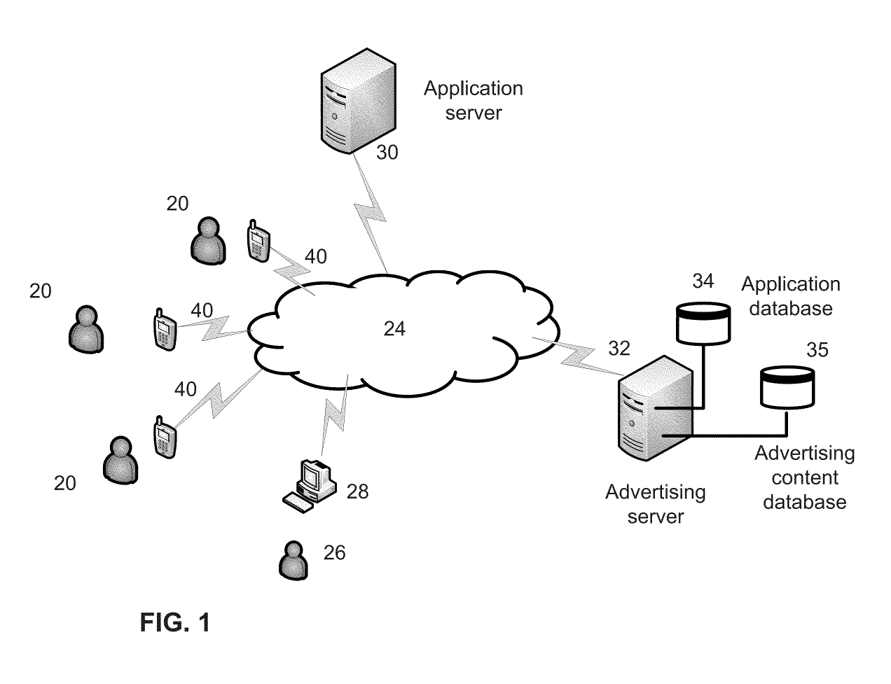

Referring to FIG. 1, a system is depicted which enables application developers to provide advertising interface views on top of their application interface views. The system comprises an application server 30 and an advertising server 32. The application server 30 is connected to the internet 24 and is typically part of an application store operated by an application provider. Examples of such application stores include the Apple App Store or Google Play. The executable code for the applications is stored on a computer readable medium that is part of the application server 30 (or operatively connected to it). When users 20 wish to obtain an application on their mobile devices 40, they wirelessly communicate with the application server 30 via the internet 24 (or another wide area network) to download the desired application executable code to at least one computer readable storage device (e.g., a flash memory, an SD card or other fixed or removable non-volatile storage) that is part of their mobile device 40. Application developers 26 interact with the application server 30 using a terminal 28 or any other type of device connected to the internet 24 and capable of inputting and transmitting data to application server 30 and/or advertising server 32 and uploading executable application files to the application server 30.

Advertising server 32 includes an application database 34. The application database 34 comprises information regarding the display of advertising on various applications. The application database 34 preferably relates the information to one or more pieces of application metadata that uniquely identify an application. Advertising server 32 includes one or more processors, memory, and at least one computer readable storage medium. In certain examples, a set of computer executable advertising instructions is stored on the at least one computer readable storage medium for receiving and processing application database 34 queries from mobile devices 40 as described further below.

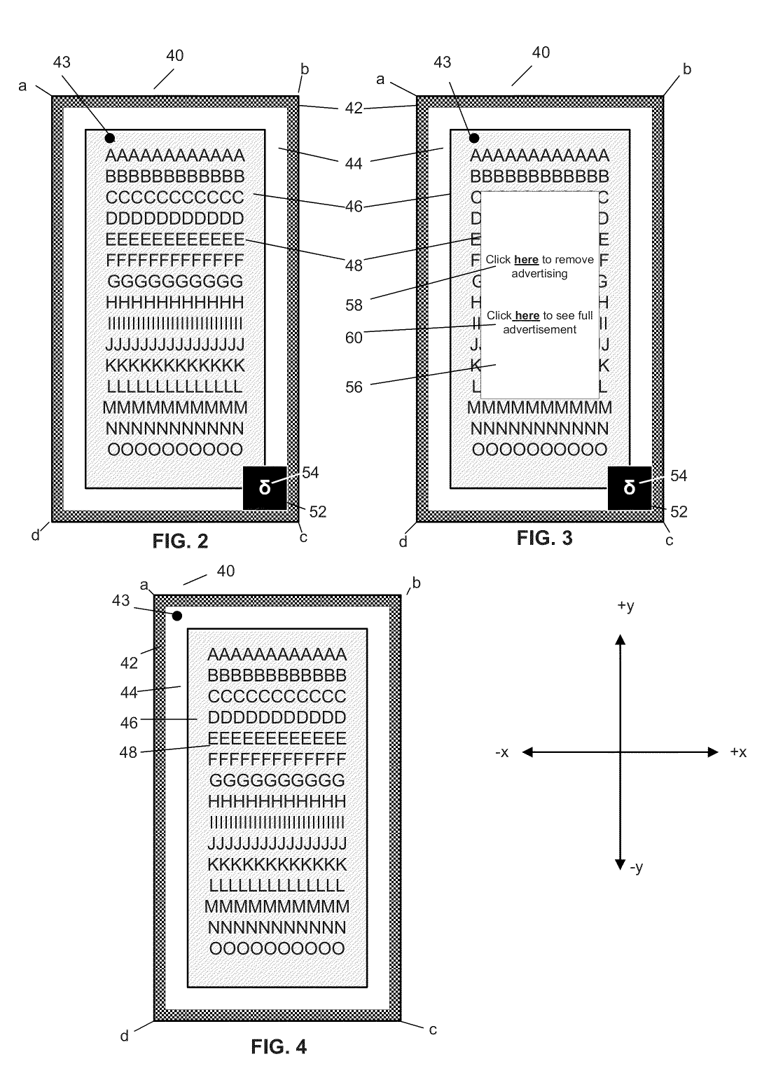

Each mobile device 40 is preferably a smart device that includes memory, a memory controller, one or more processing units (CPUs), RF circuitry, audio circuitry, a speaker, a microphone, an input output subsystem, and ports for connecting peripheral devices. As shown in FIGS. 2-4, mobile devices 40 include a housing 42 and a display 44 that is capable of displaying text, images, movies, videos, icons, animations, and other visual output (collectively, “graphics”) to a user. The memory may include high-speed random access memory and may also include non-volatile memory, such as one or more magnetic disk storage devices, flash memory devices, or other non-volatile solid-state memory devices. Access to the memory by other components of device 40, such as a CPU and/or a peripherals interface may be controlled by a memory controller.

Display 44 is also configured to receive user inputs via selection techniques such as touching, sliding, dragging and dropping, swiping, pressing, and other physical interactions with targeted areas of display 44. Display 44 may use LCD (liquid crystal display) technology, LPD (light emitting polymer display) technology, or LED (light emitting diode) technology, although other display technologies may be used in other embodiments. Display 44 and a display controller (not shown) may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with display 44. In an exemplary embodiment, projected mutual capacitance sensing technology is used, such as that found in the iPhone® from Apple Inc. of Cupertino, Calif.

Mobile device 40 may also include one or more accelerometers (not shown). In some embodiments, information is displayed on the display 44 in either a portrait view or a landscape view based on an analysis of data received from the one or more accelerometers. Mobile device 40 optionally includes, in addition to accelerometer(s) a magnetometer and a GPS (or GLONASS or other global navigation system) receiver for obtaining information concerning the location and orientation (e.g., portrait or landscape) of mobile device 40.

In some embodiments, the non-volatile storage of mobile device 40 stores one or more of an operating system, a communication module (or set of instructions), a contact/motion module (or set of instructions), a graphics module (or set of instructions), a text input module (or set of instructions), a Global Positioning System (GPS) module (or set of instructions), and applications (or sets of instructions). Suitable exemplary operating systems include the iOS operating system provided by Apple, Inc., the Android operating system provided by Google, Inc. of Mountain View, Calif., the Windows Phone Systems provided by Microsoft Corporation of Redmond, Wash., the WebOS operating system supplied by Hewlett-Packard of Sunnyvale, Calif., Blackberry OS supplied by Blackberry, Ltd. of Waterloo, Canada, and Firefox OS, provided by Mozilla of Mountain View, Calif.

Mobile device 40 may also include a contact/motion module for detecting contact with display 44 (in conjunction with a display controller). The contact/motion module includes various software components for performing various operations related to detection of contact, such as determining if contact has occurred (e.g., detecting a finger-down event), determining if there is movement of the contact and tracking the movement across the display 44 (e.g., detecting one or more finger-dragging events), and determining if the contact has ceased (e.g., detecting a finger-up event or a break in contact). The contact/motion module receives contact data from the display 44. Determining movement of the point of contact, which is represented by a series of contact data, may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts).

The contact/motion module may detect a gesture input by a user. Different gestures on display 44 have different contact patterns. Thus, a gesture may be detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the display 44 includes detecting a finger-down event followed by detecting one or more finger-dragging events, and subsequently followed by detecting a finger-up (lift off) event.

Mobile device 40 may also include a graphics module that includes various known software components for rendering and displaying graphics on display 44, including components for changing the intensity of graphics that are displayed. As used herein, the term “graphics” includes any object that can be displayed to a user, including without limitation text, web pages, icons (such as user-interface objects including soft keys), digital images, videos, animations, etc. Mobile device 40 may also include a keyboard with “hard keys” used to effect operations on mobile device 40.

The present disclosure is directed to techniques for providing users of applications with advertising. The described techniques are not limited to any particular applications. Examples of possible applications may include applications for providing contacts (e.g., in an address book or contacts list), a telephone dialer interface, video conferencing, games, e-mail, instant messaging, photographs, videos, music, a web browser, weather information, stock information, and maps, to name but a few possibilities. Users perform operations on mobile device 40 by using controls configured within a user interface provided on display 44. The controls comprise areas of the display 44 that are selectable using particular selection techniques (i.e., a finger swipe, a press, a finger pinch, etc.) to effect desired operations. The user interface may also include graphics. For example, a telephone dialer application may be configured so that selected areas of the display 44 include images of numbers which may be selected to dial (or input) the displayed number for use in placing a call. Thus, the user interface provides controls and graphics to the user. Graphics may be associated with controls or may be displayed without any associated control, depending on the nature of the particular application. Controls may also be provided on particular areas of the display 44 without a graphic or with a graphic that fully or partially overlaps the selectable area associated with the control. As used herein, the term “user interface” refers to a unique arrangement of any, some, or all of an advertising interface area, an expanded advertising interface area, an advertising control interface area, an application interface area or other interface areas that may be displayed on display 44 at a particular point in time. Thus, FIG. 1 depicts a first user interface, FIG. 2 depicts a second user interface, and FIG. 3 depicts a third user interface.

The user interfaces depicted in FIGS. 1-3 are preferably defined by composites of one or more user interface “views” or “layers.” Each view or layer is a configuration of graphics and controls (as well as their layout or spatial arrangement) within display 44. Modern smart device operating systems typically allow for the creation of “view” classes and subclasses that can be instantiated as corresponding view objects and sub-objects. Each user interface view may be configured to define certain graphics and/or controls that occupy distinct portions or all of display 44, a well as the spatial arrangement of the graphics and/or controls on display 44.

As is known in the art, certain modern smart device operating systems also allow for the creation of several interface views with a layered architecture that defines a view hierarchy. Thus, although it is not physically measurable, there is a depth dimension associated with each of the views. Different techniques are used to achieve a layered architecture. One technique uses a “stack” in which views are positioned one on top of the other. Another technique assigns a z-axis position to the various views. Each interface view provides controls and graphics in an x-y plane and may be related to other interface views along the depth dimension. This type of layered architecture allows interface developers to create user interfaces by selectively bringing different interfaces to the foreground relative to one another. Multiple views may also be displayed at a given time such that the interface area(s) generated by one view will occupy a first portion of the display 44 while an interface area generated by another view will occupy a second portion of the display 44. Multiple views may also be generated at a given time in an overlapping relationship where a first view obscures the other view on display 44 because of the relationship of their depth dimensions.

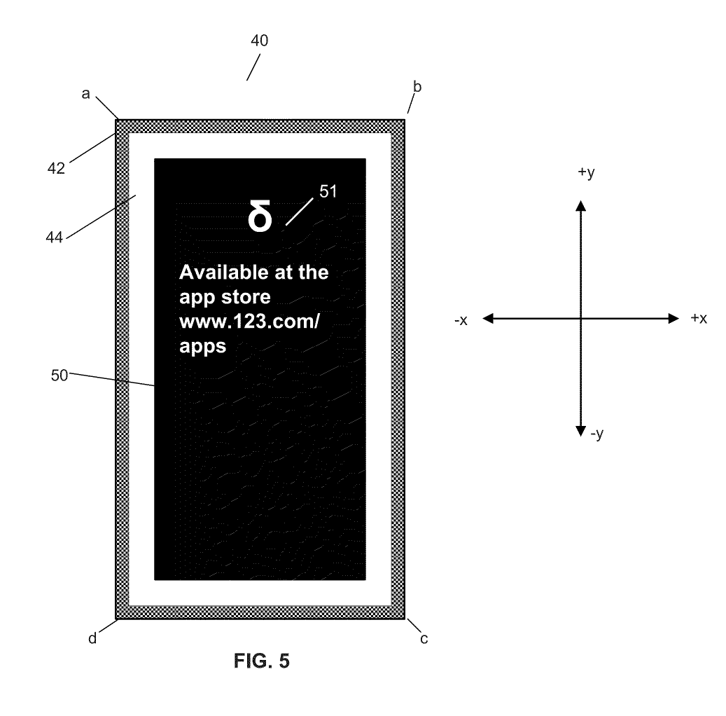

Illustrative examples of advertising interfaces will now be described with reference to FIGS. 2-6. Various advertising interface formats may be used, and in certain examples of the methods and systems described herein, the application developer may select from among a plurality of advertising interface formats to be used with their applications. FIGS. 2 and 3 depict an advertising control interface format wherein a relatively small graphic 54 is provided in part or all of an advertising interface area 52 that includes a control that is selectable to display an expanded advertising interface area 50, as shown in FIG. 5. In certain examples, an advertising interface format such as one that includes the expanded advertising interface area 50 shown in FIG. 5 may be displayed without first displaying a user selectable advertising interface control area 52.

Referring again to FIG. 2, mobile device 40 includes a display 44 displaying a first user interface that comprises an advertising control interface area 52 and an application interface area 46. The term “advertising control interface area” refers to an area of the mobile display with which the user 20 can interact to effect desired advertising-related operations. For example, a user 20 may interact with advertising control interface area 52 by touching, dragging, squeezing, or completing other physical gestures within the advertising control interface area 52 in order to effect desired advertising-related operations. In contrast, an “advertising interface area” may or may not include controls. For example, it may simply include a graphic (e.g., text, pictures, animations, etc.) with advertising content that can be viewed but with which the user cannot interact. In certain preferred examples, if the user closes the application that provides application area 46, the advertising control area 53 and graphic 54 are removed from display 44.

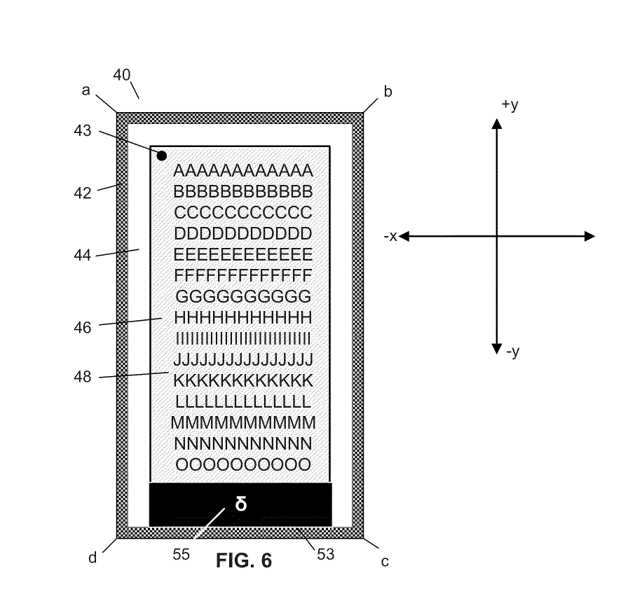

As shown in FIG. 6, an advertising interface format comprising a banner ad graphic 55 may be used. In certain examples, the format may include an advertising control area 53 that is selectable to effect desired operations (such as re-directing the user to a website corresponding to the banner ad graphic 55). In other examples, the banner ad graphic 55 may be provided without an advertising control area 53. In certain preferred examples, if the user closes the application that provides application interface area 46, the banner ad graphic 55 and advertising control area 53 are removed from display 44.

In the illustrated example of FIG. 2, the application interface area 46 does not occupy the entire display 44. However, in certain preferred examples, the application interface area 46 extends along the entire length and width of display 44. The advertising control interface area 52 is a user-selectable area that may be used to trigger one or more pre-defined operations. The advertising control interface area 52 includes a graphic 54 having content. In this case, the graphic is the small Greek letter “delta” (δ) overlaid on a square box. The “delta” text is associated with advertising content that the user can access by selecting the advertising control interface area 52. In certain examples, the advertising control interface area 52 may include a selectable area that is less than the interface area 52 and/or different from the area of display 44 occupied by graphic 54. However, in the illustrated example of FIG. 2, the graphic 54 covers the entire advertising control interface area 52, and the entire advertising control interface area 52 is selectable by a user to cause the display of a second user interface. One example of such a second user interface is provided in FIG. 5. FIG. 5 depicts a second user interface comprising an expanded advertising interface area 50 on display 44. The expanded advertising interface area 50 includes an advertisement 51 having advertising content related to the content of the graphic 54 in the advertising control interface area 52 of the first user interface (FIG. 2). As shown in FIG. 5, the expanded advertising interface area 50 does not occupy the entire area of display 44. However, in certain preferred examples it may. Referring to FIGS. 2-4, 4the application interface area 46 includes application interface content 48, which may comprise controls and/or graphics. In certain examples, the application interface content 48 is scrollable relative to an application interface reference location 43 within application interface area 46.

In preferred examples, the area of display 44 occupied by expanded advertising interface area 50 is greater than the area of display 44 occupied by advertising control interface area 52 and its associated graphic 54. The ratio of the area of display 44 occupied by the expanded advertising interface area 50 to the area of display 44 occupied by advertising control interface area 52 is preferably at least about seven, more preferably at least about ten, and still more preferably at least about twenty. In the same or other examples, the ratio is preferably no more than about 50, more preferably no more than about 65, and still more preferably no more than about 100.

In the example of FIG. 5, the second user interface does not include either the advertising control interface area 52 or the application interface area 46. In certain examples, the expanded advertising interface area 50 may be selectable to take the user to a website where the advertised goods and services can be purchased. In FIG. 5, a link to www.123.com/apps is provided so the user can purchase applications supplied under the δ trademark. In certain examples, the expanded advertising interface area 50 may be displayed for a selected period of time, after which the user interface of FIG. 1 may be displayed so that the user can return to the application.

In the specific example of FIG. 2, the advertising control interface area 52 provides an indication to the user that the application displayed in application interface area 46 is linked to an advertisement that the user can access by selecting the advertising control interface area 52 (or its graphic 54). In the example of FIG. 5, the second user interface does not include the advertising control interface area 52. However, it may include an alternative control that the user can select to remove the advertisement 51 and return to the first user interface of FIG. 2. In preferred examples, when the user closes the application displayed in application interface area, the advertising control interface area 54 and its graphic 54 are removed from display 44.

In certain examples, advertising control interface area 52 is preferably provided with “scroll-away” protection. In certain known mobile devices, application content may be scrolled along the length and/or width directions of mobile device 40 relative to a reference point 43 on the application interface area. In many known advertising solutions, this type of scrolling operation would cause the advertising control interface area 52 to disappear from display 44. However, in preferred examples herein, when a user scrolls application interface area content 48 relative to application interface area reference point 43, the location of advertising control interface area 52 remains fixed relative to the application interface area reference point 43. In those examples in which the advertising interface area is not an advertising interface control area (e.g., a graphic that is not selectable to initiate any action on the mobile device), such scroll-away protection may also be provided.

Referring now to FIGS. 2-4, an exemplary method of accessing advertising on mobile device 40 will now be described. In accordance with the method, a user may select advertising control interface area 52 using multiple selection techniques to effect multiple operations, each of which uniquely corresponds to one of the selection techniques. In one example, the user may select advertising control interface area 52 using a first selection technique to display expanded advertising interface area 50 (FIG. 5) and using a second selection technique to dismiss or remove the advertising control interface area 52 (FIG. 4). Thus, this exemplary method allows users to “opt-out” of having advertisements displayed while using selected applications. In preferred examples, the entire portion of display area 44 occupied by graphic 54 is selectable. In the same or other preferred examples, the same area on display 44 is selectable using both the first and second selection techniques to effect the operations to which the techniques respectively correspond. In other examples, the user may use a third selection technique to retain the advertising control interface area 52 but to change the graphic 54 and/or its content as well as the advertisement 51 in expanded advertising interface area 50 to which the content of graphic 54 is related. In additional examples, and as illustrated in FIG. 3, the user may use the particular selection technique to bring up a menu 56 with options for accessing expanded advertising interface area 50 or dismissing the advertising control interface area 52 altogether. In further examples, a selection technique may be used that causes the advertising control interface area 52 and/or graphic 54 to temporarily disappear with a new advertising control interface area 52 and/or graphic 54 subsequently being displayed to the user.

The first and second selection techniques (or any other selection techniques) preferably comprise unique actions taken with respect to display 44. In one example, briefly contacting (or “clicking”) on advertising control interface area 52 will launch the second user interface of FIG. 5, while longer contact on advertising control interface area 52 will remove the advertising control interface area 52 from display 44 (FIG. 4). In another example, the first selection technique may comprise a single contact with advertising control interface area 52, and the second selection technique may comprise multiple contacts with advertising control interface area 52. In yet another example, the first selection technique may comprise one or more brief contacts with the advertising control interface area 52, and the second selection technique may comprise a brief contact followed by a long contact (i.e., a “tap and hold” technique).

An alternate selection technique is illustrated in FIG. 3. In accordance with this technique, the advertising control interface area 52 is selectable to provide a set of control options, including a menu 56 with a link 60 for generating the second user interface of FIG. 5 and a link 58 for dismissing or removing the advertising control interface area 52 to yield the third user interface of FIG. 4. In certain examples, menu 56 may include a third link for dismissing the particular graphic 54 in advertising control interface area 52 and receiving new content (that is linked to a corresponding advertisement 51 in expanded advertising interface area 50). In certain preferred examples, the entire advertising control interface area 52 is selectable to cause the display of menu 56.

In certain examples, the graphic 54 and/or its content (e.g., the small letter “delta”) in the advertising control interface area 52 (FIG. 1) is dynamically updated with content transmitted by the advertising server 32 which is stored in advertising content database 35. For example, GPS coordinates or information regarding user preferences may be used to dynamically determine which advertising information to provide in advertising control graphic 54 and advertisement 51.

In certain examples, the user interfaces shown in FIGS. 2-6 are defined by compositing multiple user interface views (layers) to create a view hierarchy. Referring to FIG. 2, in one example advertising control interface area 52 is defined by an advertising control interface view, and application interface area 46 is defined by an application interface view on which the advertising control interface view is overlaid. The views may define controls and graphics that extend across the entirety of a parent view to which they belong or a portion thereof. However, in FIG. 1 the advertising control interface view defines an advertising control interface area 52 that does not extend beyond the graphic 54 depicted in the figure. Therefore, the advertising control interface view can be overlaid on the application user interface view without obscuring much or any of the application interface area 46 or its application interface area content 48. The two views are displayed simultaneously in an overlapping relationship. However, the advertising control interface view does not define controls or graphics outside of the advertising control interface area 52. Thus, when the views are displayed simultaneously, most or all of the application interface area 46 is visible. In preferred examples of the advertising methods and systems described herein, the advertising control interface view comprises a set of computer executable advertising interface instructions stored on a computer readable storage medium on mobile devices 40 separately from computer executable application instructions that comprise the application interface view. In additional preferred examples, the compiled and executable code used to generate the application interface area 46 includes none of the computer executable instructions used to generate the advertising control interface area 52. In contrast, certain known techniques for providing advertising interface views in a software development kit (SDK) require the application developer to compile the SDK with the application code, resulting in an integrated set of computer executable application instructions that also include computer executable advertising interface instructions that generate an advertising interface area (or advertising interface control area) on the mobile device display 44. In that case, the advertising interface view effectively becomes the responsibility of the application developer, and any updates to the advertising interface view require recompilation of the application code and uploading of the re-compiled application code to application server 30.

In certain examples, the user interface of FIG. 5 is defined by an expanded advertising interface view that defines expanded advertising interface area 50. In some embodiments, the application user interface view may initially be overlaid on top of the expanded advertising interface view so that the application interface area 46 obscures the advertising 51 until the advertising 51 is to be displayed to the user. In other embodiments involving operating systems that associate interface layers with z-axis coordinates, the expanded advertising interface view used to generate expanded advertising interface area 50 is generated before it is displayed (i.e., the code used to create the expanded advertising interface view is executed before the expanded advertising interface area 50 is displayed) and assigned a z-axis coordinate that is beneath that of the application interface view and the advertising control view when the first user interface of FIG. 2 is displayed. When the user interface of FIG. 5 is displayed, the z-axis coordinate of the expanded advertising interface view is altered so that it is displayed and the application interface view and advertising control interface views of FIG. 1 are obscured. In other embodiments that involve operating systems that provide “stacked” layers, the expanded advertising interface view is generated before it is displayed and pushed to a higher (foreground) stack position when the second user interface of FIG. 5 is displayed, and the application interface view and/or advertising control interface view is pushed to a lower (background) position when the second user interface of FIG. 5 is displayed. In other examples, the expanded advertising interface view is not provided in a stacked arrangement. Instead, when a user selects the advertising control interface area 52 with a first selection technique, the expanded advertising interface view is generated at that point in time such that it overlays the application interface view and the advertising control view.

In certain preferred examples, the mobile devices 40 include at least one computer readable storage medium having computer executable advertising interface instructions stored thereon. When executed by a processor on the mobile device, the computer executable advertising interface instructions cause an advertising interface area to be displayed on the mobile device 40 display. Exemplary advertising interface areas include the advertising control interface area 52 of FIG. 2, the expanded advertising interface area 50 of FIG. 5, and the banner advertising interface area 53 of FIG. 6. The advertising interface area is part of an advertising interface view that is displayed on top of an application interface view for the application executing in the foreground on mobile device 40.

The advertising interface view comprises a set of computer executable advertising interface instructions defined by an advertising interface view object. The application interface view causes an application interface area such as application interface area 46 of FIGS. 2-4 and 6 to be displayed on the mobile device 40. The application interface view is defined by a portion of a set of computer executable application instructions stored on the at least one computer readable storage medium of mobile device 40. However, in preferred examples, the computer executable application instructions are separate from the computer executable advertising interface instructions. As a result, the execution of the application, in and of itself, does not generate the advertising interface. In certain examples, the advertising interface view object is stored on the at least one computer readable medium of the mobile device 40 before the computer executable application instructions (which may comprise an application object) are stored on it.

In accordance with one aspect of the present disclosure, a method of displaying advertising on a mobile device 40 is provided. The mobile device 40 includes a processor, a display 44, and a plurality of applications, each defined by computer executable application instructions stored on a non-volatile storage device of the mobile device 40. The method comprises identifying an application among the plurality of applications which is executing in the foreground on the mobile device and determining if advertising has been enabled for the executing foreground application. If advertising has been enabled, advertising content corresponding to the executing foreground application is received from advertising server 32. An advertising interface view is displayed on the mobile device display 44 on top of an application interface view for the executing foreground application. The advertising interface view comprises a graphic including the received advertising content. The advertising interface view is preferably defined by a set of computer executable advertising interface instructions stored on a computer readable medium on the mobile device 40.

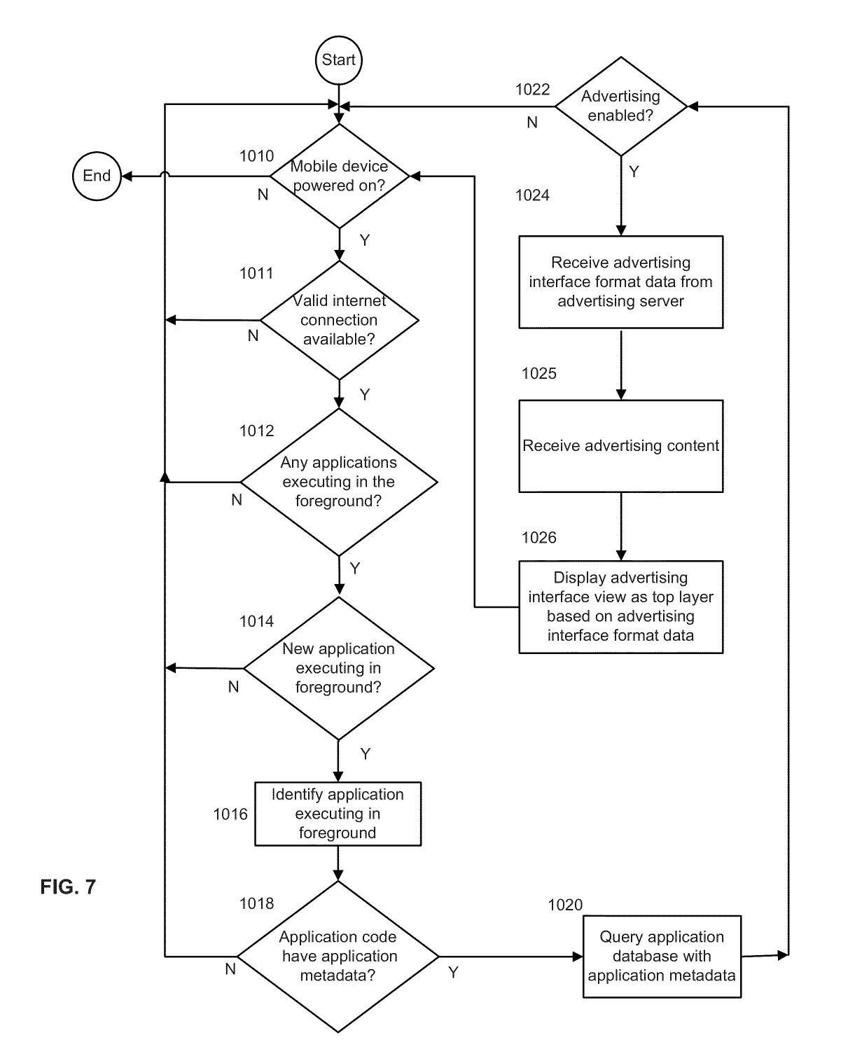

In certain examples, the computer executable advertising interface instructions stored on the mobile device 40 perform the steps shown in FIG. 7. Referring to the figure, in step 1010 the instructions determine if the mobile device 40 is powered on. If it is not, the process ends. If the device is powered on, control transfers to step 1011 and a determination is made as to whether the mobile device 40 has a valid internet connection. If it does, control transfers to step 1012. Otherwise, control transfers to step 1010. In step 1012, a determination is made as to whether any applications are executing in the foreground. As is known to those skilled in the art, a foreground application is one that currently has the input focus such that if a user were to perform a control gesture or input data, it would be processed by the foreground application. Other applications may be executing in the background while an application is executing in the foreground. In step 1012, if no applications are executing in the foreground (e.g., if the user is simply on the mobile device 40 home screen), control returns to step 1010.

The set of computer executable advertising interface instructions then determine if there is a new application executing in the foreground, i.e., if there is an application that is executing in the foreground which differs from the last time step 1014 was performed. If there is no new application executing in the foreground, control returns to step 1010. Otherwise, control transfers to step 1016. In step 1016, the computer executable advertising interface instructions identify the application that is executing in the foreground, e.g., by identifying the name of the corresponding executable file stored on the at least one computer readable storage medium of mobile device 40. The instructions then determine whether the foreground application is one that has been subscribed for advertising. In the example of FIG. 7, this determination is performed by checking the application code to determine if it has application metadata.

As used herein, the term “application metadata” is an identifier that is not visible to application users and which can be used to uniquely identify an application. In certain examples, the application metadata comprises a string of letters, characters, and/or symbols. One suitable example of application metadata is an application programming interface key or “API Key.” Another suitable example is the application's package name. An additional suitable example is an authorization certificate. A further suitable example of application metadata is a public key certificate. Applications may have a variety of application metadata. However, in the specific illustrative example of method of FIG. 7, the application metadata of step 1018 is preferably only present in the computer executable application instructions if the application has been subscribed for advertising. Thus, step 1018 determines if the foreground application is subscribed for advertising. If the foreground application is not subscribed for advertising, control transfers to step 1010. Otherwise, the application metadata is retrieved, and control transfers to step 1020.

In step 1020, the computer executable advertising interface instructions transmit the application metadata to advertising server 32. The application metadata may be transmitted to advertising server 32 in an encrypted form and used by server 32 in the encrypted form or first unencrypted by server 32 and used in an unencrypted form. A set of computer executable advertising instructions stored on a computer readable medium in or operatively connected to advertising server 32 then queries an application database 34 (FIG. 1) to determine if advertising is currently enabled based on advertising enablement information stored in the application database 34 in association with the application metadata. If advertising is not currently enabled, in step 1022 the mobile device 40 receives advertising enablement information indicative of non-enablement from advertising server 32, and control transfers to step 1010. If advertising is enabled, control transfers to step 1024.

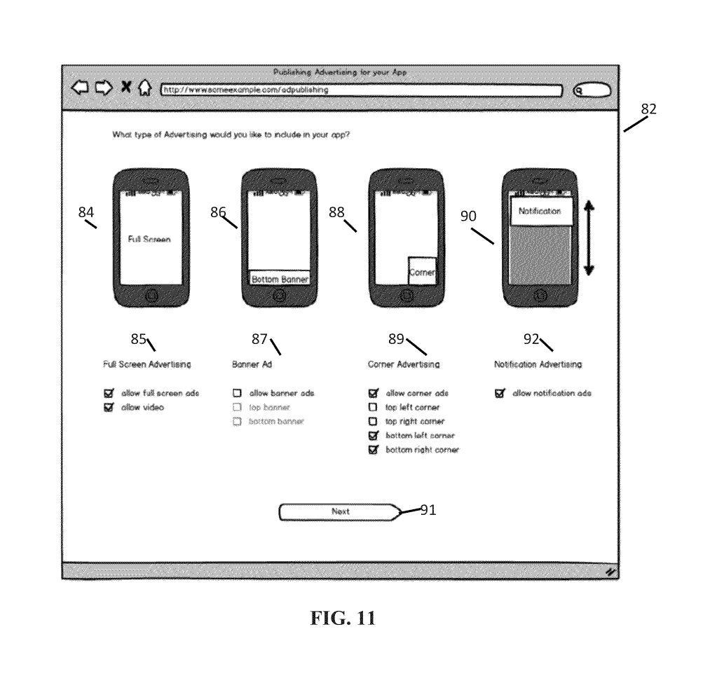

If advertising is enabled, the computer executable advertising instructions on advertising server 32 query the application database 34 using the application metadata received from mobile device 40 to determine which advertising interface format or formats have been selected for the executing foreground application. Exemplary advertising interface formats are shown in FIG. 11 and will be described further below. In step 1024, the mobile device 40 receives the retrieved advertising interface format data from the advertising server 32. The computer executable advertising instructions stored on the advertising server will also retrieve advertising content from the advertising content database 35 which corresponds to the application metadata. The advertising server 32 transmits both the advertising content and the advertising interface format data to mobile device 40.

In certain examples, the advertising server 32 also includes an advertising content database 35, which may be stored on a computer readable storage medium within the housing of the advertising server 32 or provided separately and operatively connected to the advertising server 32 processor(s) and memory. The advertising content database 35 includes items of advertising content (e.g., text, images, animations, sounds, etc.) that may be displayed in an advertising interface view on the mobile device display 44. In certain examples, the advertising content database 35 may be integrated with the application database 34 instead of comprising a separate database. In step 1025 the mobile device 40 receives advertising content provided by advertising server 32. The advertising content is included in the advertising interface view generated on top of the application interface view of the executing foreground application on the mobile device 40. In step 1026 the computer executable advertising interface instructions stored on the at least one computer readable storage medium of mobile device 40 display an advertising interface view on top of an application interface view based on the received advertising content and advertising interface format data. Control then transfers to step 1010. If the user closes the foreground application, either step 1012 or step 1014 will return a value of NO. In preferred examples, when a value of NO is returned, the advertising interface area 52 and its associated graphic 54 (FIG. 2) will be removed from display 44. Similarly, in implementations where a banner ad graphic 55 and associated control area 53 are used (FIG. 6), they will similarly be removed from display 44 if the foreground application is closed.

In some implementations, each application stored on mobile device 40 will have some form of existing application metadata associated with it regardless of whether advertising is to be provided for the application. This existing application metadata can also be used to determine if advertising is to be provided for the associated application. However, the mere presence or absence of the existing application metadata on the mobile device 40 will not unambiguously indicate whether the application is subscribed for advertising. In one modified version of the method of FIG. 7, such existing application metadata for whatever application is executing in the foreground may be retrieved and transmitted to advertising server 32. Computer executable instructions executed by the advertising server 32 may then compare the received application metadata to data in the application database 34 to determine if the application is subscribed for advertising. If it is subscribed, the application databases 34 and advertising content database 35 would be queried using the received application metadata (or other information corresponding to it) as a query key, and the relevant advertising information from database 34 and/or database 35 for the executing foreground application would be transmitted from advertising server 32 to mobile device 40 as in steps 1024-1026 of FIG. 7. If the application is not subscribed for advertising, appropriate data would be transmitted to mobile device 40 indicating that no advertising is to be provided and control would transfer to step 1010 in FIG. 7.

In another modified implementation of the method of FIG. 7, each application stored on mobile device will have some form of existing application metadata associated with it regardless of whether advertising is to be provided for the application. However, the existing application metadata will only be stored in a specified file on a computer readable medium in mobile device 40 if advertising is enabled. In one implementation, application metadata is generated when the application developer contracts with an application distributor (e.g., Google or Apple) to distribute the application (e.g., via application server 30 in FIG. 1). In the process of subscribing for advertising, the application metadata is stored in a specific file, such as a manifest file, only if advertising is to be provided for the application. The computer executable advertising interface instructions can then determine in step 1018 of FIG. 7 whether the existing application metadata is stored in the specific file to determine whether advertising is to be provided. If the application metadata is not stored in the specific file, control transfers to step 1010. Otherwise, control transfers to step 1020 and the method of FIG. 7 proceeds.

The steps of FIG. 7 are carried out by a set of computer executable advertising interface instructions stored on a computer readable medium on a mobile device 40. However, as indicated above, a set of computer executable advertising instructions is stored on advertising server 32. This set of computer executable advertising instructions is used to retrieve advertising enablement data, advertising interface format data, and advertising content from application database 34 and/or advertising content database 35.

In certain examples, the computer executable advertising instructions stored on advertising server receive queries from mobile devices 40 for advertising information related to the applications executing in the foreground on mobile devices 40. The computer executable advertising instructions process the queries using data in application database 34. In certain examples, the computer executable advertising instructions cause advertising content from advertising content database 35 to be retrieved and transmitted to a mobile device 40. The computer executable advertising interface instructions stored on the mobile device 40 then display the advertising content on the display 44 of the mobile device 40 in accordance with the advertising interface format data provided by the application developer.

In accordance with another aspect of the present disclosure, a method of providing advertising in a system of mobile devices 40 (FIG. 1) is provided. Each mobile device 40 has a processor and at least one computer readable storage medium with a set of computer executable advertising interface instructions stored on it. When executed by the processor, the computer executable advertising interface instructions display an advertising interface view as a top view on a display of a mobile device. The method comprises providing a website comprising input fields that include an advertising enablement field that determines whether advertising is enabled for the application identified by the application metadata. In accordance with the method, advertising enablement data from the advertising enablement input field is stored in application database 32 in association with corresponding application metadata for applications that are subscribed for advertising. An application database query is received from one of the mobile devices 40, and the query includes application metadata for an application executing in the foreground on the one of the mobile devices 40. Advertising content is transmitted to the one of the mobile devices 40 if the advertising enablement data corresponding to the application metadata for the executing foreground application indicates that advertising is enabled for the executing foreground application.

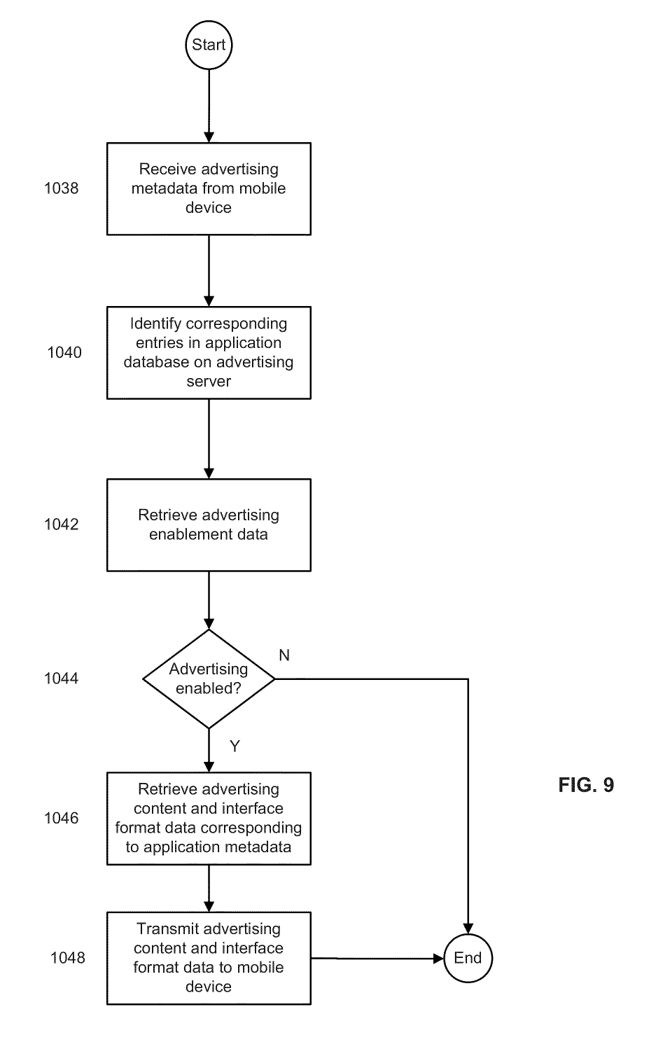

One example of a method of providing advertising content in a system of mobile devices 40 is depicted in FIG. 9. In accordance with the method, advertising server 32 receives advertising metadata from a mobile device 40 (Step 1038). The advertising metadata is used as a key used by the application database 34 to retrieve advertising data related to the application executing in the foreground of the mobile device 40. In step 1040 the computer executable advertising instructions identify entries in the application database 34 which correspond to the application metadata. In step 1042 the computer executable advertising instructions retrieve advertising enablement data from application database 34. An example of advertising enablement data is provided in the Ad Enable Flag column 116 of database table 114 in FIG. 15 (described below). In step 1044 if the advertising enablement data indicates that advertising is not enabled (e.g., if the advertising enablement flag is set to OFF), the method ends. Otherwise control proceeds to step 1046. In step 1046, the computer executable advertising instructions retrieve advertising content and advertising interface format data corresponding to the application metadata received from mobile device 40. For example, and as discussed further below, if the application metadata is the API Key in the first row and column 115 of FIG. 15, values of ON for Format 1, Format 3, and Format 4 and OFF for Format 2 may be retrieved from application database table 114. In addition, one or more of the graphics listed in the columns 128-136 of FIG. 16 may be retrieved.

In step 1048 advertising content corresponding to the API key for the executing foreground application and columns 128-136 of FIG. 16, as well as the advertising interface format data corresponding to columns 116-124 of FIG. 15, are transmitted to the mobile device 40. The computer executable advertising interface instructions stored on the mobile device 40 then cause the display of the advertising content in accordance with the advertising interface format data. In certain examples, the advertising content may be tailored to only particular interface formats, in which case additional data fields may be provided in the advertising content database 35 which indicate the association between the advertising content (columns 128-136 of FIG. 16) and the advertising interface format data (columns 116-121 of FIG. 15). In other examples, the computer executable instructions on advertising server 32 will selectively transmit only one particular item of advertising content to mobile device 40 at any one time. In other examples, the advertising server 32 will sequentially provide different items of advertising content from the advertising content database 35 to the mobile device. For example, in the case of the application corresponding to the first API key in the API key column 127 of FIG. 16, the computer executable advertising instructions may provide Graphic A.jpg to the mobile device 40 and then after a selected period of time provide Graphic B.jpg to the mobile device 40. In this way, the user of mobile device 40 may be exposed to multiple advertisements with a particular application as the application executes in the foreground.

As indicated previously, the computer executable advertising interface instructions that perform the steps of FIG. 7 are preferably stored on a computer readable storage medium of the mobile devices 40 of FIG. 1. The process of storing the computer readable advertising interface instructions on mobile devices 40 may be carried out in different ways. One exemplary method comprises loading a set of computer executable advertising interface instructions on a mobile device 40, wherein, when executed by a computer processor, the computer executable advertising interface instructions identify an executing foreground application from among a plurality of applications loaded on the mobile device 40 (i.e., stored on a computer readable medium on the mobile device 40). The computer executable advertising interface instructions determine if advertising has been enabled for the executing foreground application and receive advertising content corresponding to the application if advertising has been enabled for it. The computer executable advertising interface instructions then display an advertising interface view including a graphic with the received advertising content on the mobile device display if advertising has been enabled for the executing foreground application.

In accordance with one exemplary method, in the foregoing “loading” step, the original equipment manufacturer (OEM) of mobile devices 40 stores the set of computer executable advertising interface instructions on a computer readable storage medium for each mobile device 40 prior to delivering the mobile device 40 to a point-of-sale to consumers. In another method, an operating system provider (e.g., Google in the case of the Android operating system and Apple in the case of the iOS operating system) includes the set of computer executable advertising interface instructions as part of the operating system executable code. The operating system is then delivered to the OEM for incorporation into the mobile device 40. In yet another method, users of mobile devices 40 with a particular operating system may receive a modified operating system transmitted from the operating system provider by wireless download via the internet 24, wherein the modified operating system includes the computer executable advertising instructions.

The computer executable advertising interface instructions may also be provided by a secondary application that executes in the background to provide an advertising interface view on top of an application interface view of an executing foreground application. The user 20 may download the secondary application from application server 30 via the internet 24. The secondary application comprises a set of computer executable secondary application instructions stored on the at least one computer readable medium of mobile device 40. When the mobile device 40 is powered on, the secondary application will execute the set of computer executable advertising interface instructions such as those in the example of FIG. 7 to provide an advertising interface view on the interfaces of primary applications executing in the foreground. Thus, in certain examples, a user downloads the computer executable primary application instructions and the computer executable secondary application instructions from application server 30.

Referring again to FIG. 7, steps 1012-1016 require a determination of whether any applications are executing in the foreground, whether a foreground application is newly executing, and an identification of a newly executing foreground application, respectively. These steps may be carried out in a variety of different ways. In one example, the mobile device 40 operating system is modified to include a “listener” service. As is known to those skilled in the art, a listener service receives data generated by the operating system whenever a new application is executed in the foreground. Thus, the operating system of the mobile device 40 may be modified to include a listener service to carry out steps 1012-1016. In another implementation, the operating system of mobile device 40 may be modified to include a “callback” function. In this implementation, when an application is launched on mobile device 40, the computer executable advertising interface instructions are passed as an argument to the callback function along with the application metadata (if it exists) for the launched application. This process causes the computer executable advertising interface instructions to be executed. If the application metadata exists (step 1018), it is used in step 1020 to query the application database and the method of FIG. 7 proceeds to step 1022. If the application metadata does not exist, the process of step 1018 returns a value of NO and control transfers to step 1010. In the callback function implementation, step 1012 occurs when the most recently launched application passes the computer executable advertising interface instructions to the callback function. Steps 1014 and 1016 are not necessary in the callback function implementation because the computer executable advertising interface instructions will be executed whenever a new application is launched. Thus, it is unnecessary to check whether a new application is executing in the foreground or to identify it.

Many known operating systems do not make the data required by a listener service accessible to applications. Thus, in certain cases, the use of a listener service can only be used by appropriately modifying the operating system of mobile device 40. Thus, an alternate approach may be used when the computer executable advertising interface instructions are provided as part of the set of computer executable secondary application instructions that comprise a secondary application executing in the background. In accordance with this approach, the set of computer executable secondary application instructions continually queries the status of each application stored on the mobile device 40 to determine if it is executing in the foreground and identifies the application that is doing so.

As shown in FIG. 1, the advertising server 32 includes an application database 34. The application database 34 may be a relational database or a non-relational database stored on a computer readable storage medium within the housing of the advertising server 32 or in a separate computer readable storage medium but still operatively connected to the advertising server 32 processor and memory (e.g., connected to a printed circuit board on which the processor(s) and memory are mounted). The application database 34 may also be stored in a distributed manner across multiple computer readable storage media. The application database 34 stores information related to the application and the advertising interface view for each application. In certain examples, the application database 34 comprises a plurality of data tables, each including certain information related to applications and their advertising interface views. The tables are preferably relatable by a common key. In certain examples, the common key is application metadata. In other examples, the application metadata is an API key.

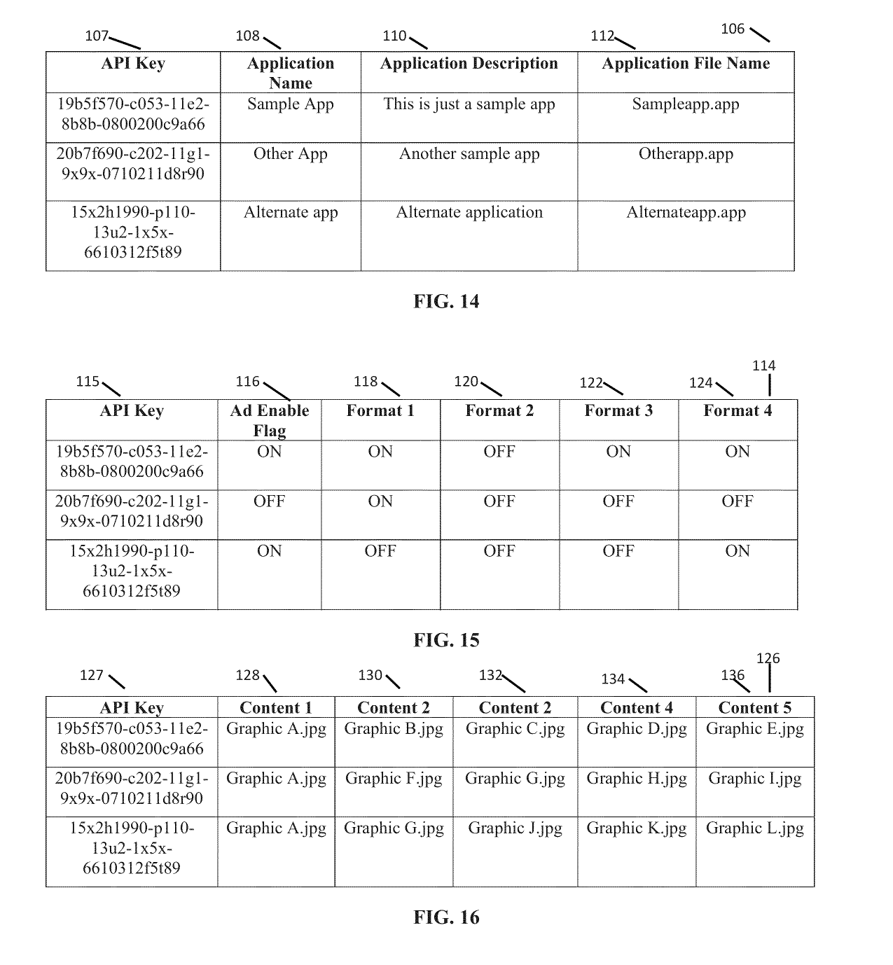

A first exemplary data table 106 from the application database 34 is shown in FIG. 14. Column 107 includes the application metadata for several applications that are subscribed for advertising. In the particular example of FIGS. 14-16, the application metadata is an API key. Column 108 includes an application name. Column 110 includes an application description, and column 112 includes an application file name, which preferably refers to the specific file name of the application as it is stored on the mobile devices 40. As the table indicates, the API keys are alphanumeric identifiers that uniquely correspond to and identify each application. In the illustrated example, several pieces of information about each application are stored in association with that application's application metadata.

Another exemplary table 114 from the application database 34 is illustrated in FIG. 15. Table 114 stores a plurality of advertising interface view data items for each application in association with the application's application metadata. Column 115 includes the application metadata for each application, which in the illustrated example comprises an API key. Column 116 includes the value of an advertising enable flag. In certain preferred examples, application developers are provided the ability to selectively enable and disable advertising for their applications. The advertising enablement flag may be used by the computer executable advertising interface instructions stored on mobile devices 40 to determine whether to display an advertising interface view on top of an application interface view of an executing foreground application. In one example, the advertising enable flag is used in step 1022 of FIG. 7. Table 114 may also include advertising interface format information. In the illustrated example, the advertising interface format information is provided in columns 118-124. Each column 118-124 corresponds to a particular advertising interface format. The data value in each column 118-124 of a given row indicates whether that particular format is enabled for the application identified by the application metadata in that row. In the example illustrated by tables 106 and 114, the application called “Sample App” has advertising enabled and allows the use of formats 1, 3, and 4. The application called “Other App” does not have advertising enabled. However, it was previously configured to use format 1 only as indicated by the ON value in column 118. The application called “Alternate app” has advertising enabled and allows the use of format 4 only.

By way of example, if the application called “Alternate App” is executing in the foreground of a mobile device 40, in step 1022 of FIG. 7, the mobile device 40 will receive the value of ON for the ad enable flag. In step 1024, the mobile device 40 will receive values of OFF for formats 1-3, and a value of ON for format 4. The computer executable advertising interface instructions stored on the mobile device 40 will use the ad enable flag and advertising interface format data from Table 114 to generate appropriate advertising interface views on top of the application interface view for Alternate app. The application interface view for Alternate app. is generated by a set of computer executable application instructions stored in the file Alternateapp.app on a computer readable storage medium in mobile device 40. The tables 106 and 114 may be configured in ways other than those shown in FIGS. 14 and 15. For example, a single table may be used which combines columns 108, 110, 112, 116, 118, 120, 122, and 124 with a single API key column. In another variation, the information in Tables 106 and 114 may be provided in more than two tables, each of which is keyed off of the API key.

Referring again to the example of FIG. 7, if application database 34 is configured as shown in illustrative tables 106 and 114, in step 1022 the mobile device 40 determines whether advertising is enabled based on the value of the advertising enablement flag (column 116 in FIG. 15) received from the advertising server 32. If advertising is enabled, in step 1024 the mobile device 40 receives advertising interface format data (columns 118-124) from the advertising server 32.

As mentioned previously, in the example of FIG. 1, advertising server 32 includes or is operatively connected to an advertising content database 35. The advertising content database 35 is a relational or non-relational database that relates application metadata for a plurality of applications to a plurality of advertising content items. FIG. 16 includes an exemplary table 126 used to illustrate an advertising content database. In table 126, column 127 includes application metadata, such as an API key. Columns 128-136 include content items for each application. In the illustrated example, each content item is an image stored as a .jpg or “jpeg” file. However, other types of content and file types may be used. In some implementations, a set of computer executable advertising instructions on the advertising server will selectively retrieve content items and transmit them to a mobile device 40 for display with their corresponding application (as identified by the application metadata). The plurality of different advertising content items for each application allows different content items to be provided (e.g., serially or cyclically) to a given application as it continues to execute in the foreground and/or to select the content item or items that may be most suitable for the user 20 at a particular moment. In one example, each content item may be related (through another database) to a set of GPS coordinates, and the set of computer executable instructions on the advertising server 32 may select the content item that has a location that is the closest to the user's location (assuming the mobile device 40 is GPS enabled at the time). As shown in Table 126 different applications may have advertising that is common to the applications or unique to the applications. Thus, the applications “Sample App,” “Other App,” and “Alternate App” may each display “Graphic A.jpg” in an advertising interface view. “Other App” and “Alternate App” may each display “Graphic G.jpg” in an advertising interface view. However, “Alternate App” is the only application that will display “Graphic J.jpg,” “Graphic K.jpg,” or “Graphic L.jpg.”

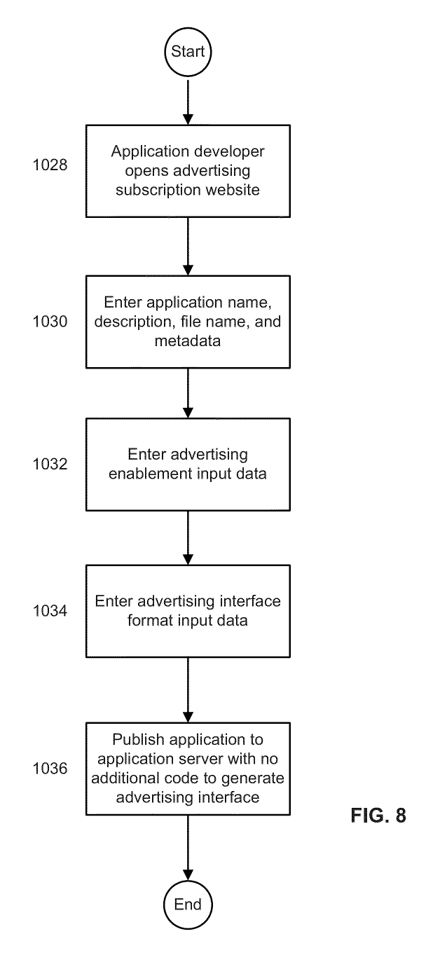

Certain implementations of the systems and methods described herein advantageously allow application developers to provide advertising with their applications without creating any code for generating an advertising interface view and without including any code for creating an advertising interface view in their application code (i.e., the set of computer executable application instructions). A method of providing advertising on a system of mobile devices 40 which includes these advantages is exemplified in FIG. 8. In accordance with the method, a plurality of mobile devices 40 includes a set of computer executable advertising interface instructions stored on their respective computer readable storage media. When executed by the mobile device 40 processors, the computer executable advertising interface instructions generate an advertising interface view on top of an application interface view for an executing foreground application. The application interface view is generated by a set of computer executable foreground application instructions stored on a computer readable storage medium on the mobile device 40. The computer executable foreground application instructions are stored separately from the computer executable advertising interface instructions, i.e., they are not in the same executable file.

Referring to FIG. 8, the application developer opens an advertising subscription website in step 1028. The advertising subscription website is used as a portal through which the application developer can enter information in order to provide advertising with his or her application. In step 1030, the application developer inputs application data into the advertising subscription website. Examples of such application data include an application name, an application description, an application file name, and application metadata as illustrated in FIG. 14. In step 1032, the application developer inputs advertising enablement data into the advertising subscription website. In certain examples, the advertising enablement data is a flag with values ON or OFF. Alternatively, the flag may have values of “1” or “0” which represent an “ON” and “OFF” state, respectively.

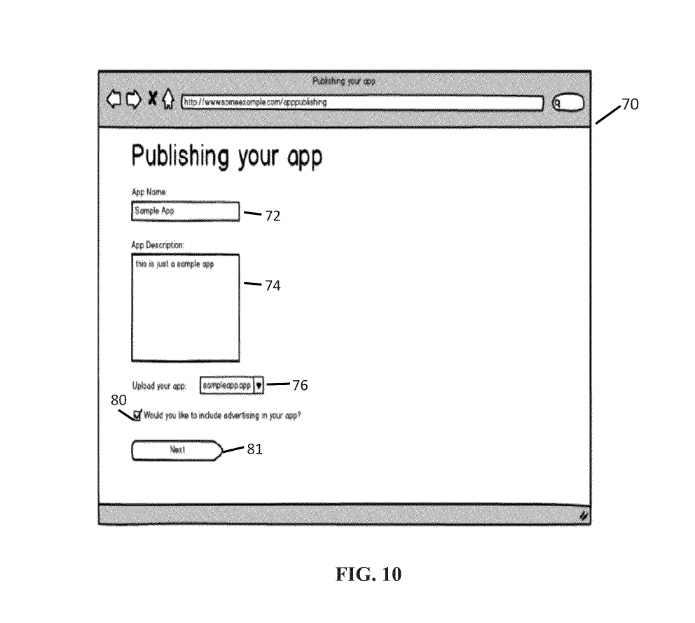

The advertising enablement data allows the application developer to selectively activate or deactivate advertising for a given application. For example, certain application developers may only want to include advertisements prior to certain holidays or annual events. In that case, they would set the advertising enablement flag to ON prior to those holidays or events and set it to OFF during the remainder of the year. Note that the application developer will not necessarily enter the text ON or OFF. Instead, he or she may simply use a check box, drop-down menu, radio button, or use any other known means for inputting data into a website, as discussed below with respect to FIG. 10.

In step 1034, the application developer inputs advertising interface format data into the advertising subscription website. In certain examples, and as illustrated in FIG. 11 (discussed further below), the advertising subscription website may present the application developer with a number of possible advertising interface formats, and the application developer may select one or more of them for use in presenting advertising on the developer's application. Examples of such formats are described below with respect to FIG. 11. In step 1036 the application developer publishes the application to application server 30, where it is stored for subsequent downloading by users 20 onto their respective mobile devices 40. As noted, in step 1036 the application code (i.e., the set of computer executable application instructions) is published without any additional code for generating an advertising interface view. In FIG. 8 step 1036 is shown as being last, however, the application can be published before beginning any of the other steps in FIG. 8.

In certain implementations, the process of FIG. 8 may include one or more additional steps for generating application metadata for the application. If the party providing advertising services (e.g., the party responsible for operating application database 34 and advertising content database 35) is the same party responsible for distributing the application to users such as via application server 30 (e.g., Google through the Google Play store or Apple through the Apple App Store), then it may already receive application metadata (such as a package name for the application, an API key, or an encrypted form of the package name or API key) when the application developer subscribes for application distribution via application server 30. This application metadata may be used to determine if the application is subscribed for advertising. However, because the application metadata exists independently of whether the application is subscribed for advertising, it is preferably used in a manner that unambiguously indicates whether advertising is to be provided. In one implementation, the existing application metadata is transmitted to the advertising server 32 which then executes computer executable advertising instructions that compare the application metadata to data in application database 34 to determine if the application is subscribed for advertising. In another implementation, the existing application metadata is stored in a particular file location on mobile device 40, and the computer executable advertising interface instructions stored on mobile device 40 read the file to determine if it includes the application metadata to carry out step 1018 of FIG. 7.

If parties other than the application distributors are providing advertising services (e.g., an operating system provider or the developer of a secondary application that executes in the background to provide an advertising interface view on top of an application interface view of an executing foreground application), then FIG. 8 may include the optional step of generating new application metadata that the developer will add to the application code (e.g., in an application manifest file) so that advertising server 32 can confirm that the application is subscribed for advertising. In the example of FIG. 7, the newly generated application metadata would be used in steps 1018 and 1020.

Examples of web pages suitable for implementing the method of FIG. 8 are provided in FIGS. 10-13. Referring to FIG. 10, the application developer opens up a web page 70 in a web browser. Web page 70 includes various data entry input fields related to the application for which advertising will be provided. Data entry field 72 provides a location to enter a name of the application of interest, which in the example of FIG. 10 is called “Sample App.” Data entry field 74 provides a location to enter a description of the application, which in the example of FIG. 10 is “this is just a sample app.” Data entry field 76 is a drop down box that allows the application developer to browse locations on the storage medium of the computer being used to access web page 70 to locate the file directory and name for the application executable code to be published. In the example of FIG. 10, the application executable code is stored in a file called “sampleapp.app.” Computer executable instructions associated with web page 70 cause the executable code identified in the file name entered in field 76 to be uploaded to the application server 30 and the file name to be stored in column 112 of table 106 (FIG. 14) of application database 34. In certain examples, the uploading and storage operations occur when the application developer selects the “next” button 81. In certain examples, the selection of next button 81 causes the application name entered in field 72 to be stored in column 108 of table 106 (FIG. 14) and causes the application description entered in field 74 to be stored in column 110 of table 106.

The application developer can simply provide the application without advertising by then selecting the “next” button 81 while leaving the advertising enablement data entry field 80 un-checked. However, if the application developer wishes to enable advertising, he or she may select the advertising enablement data entry field 80, causing a check-mark to appear. Computer executable instructions associated with web page 70 set an advertising enablement flag to ON when advertising enablement data entry field 80 is selected. In certain examples, the advertising enablement flag value is stored in the application database as illustrated in column 116 of table 114 (FIG. 15). The advertising enablement flag value may then be used by the computer executable advertising interface instructions on the mobile devices 40 to determine whether a given application will display an advertising interface view on top of an application interface view. In one example, the advertising enablement flag value may be used in step 1022 of FIG. 7 to allow the computer executable advertising interface instructions on a mobile device 40 to determine whether advertising is enabled for the application currently executing in the foreground. In another example, computer executable advertising instructions on advertising server 32 may receive the value of the advertising enablement flag value in step 1042. In certain examples, the value of the advertising enablement flag is stored in column 116 of table 114 (FIG. 15) in the application database 34.

If the application developer sets the advertising enablement flag value to ON by selecting advertising enablement data entry field 80, web page 82 (FIG. 11) will be displayed when the developer selects the “next” button 81 on web page 70. Web page 82 provides a mechanism by which an application developer can select one or more advertising interface formats to be used with his or her application. Web page 82 includes a plurality of advertising interface format images 84, 86, 88, and 89 which each illustrate a manner in which advertising may be displayed on the application interface of an application executing in the foreground of a mobile device 40. For example, image 84 illustrates an expanded advertising interface area format in which advertising content occupies all or substantially all of the display 44 (FIG. 1). The full screen advertising may be displayed temporarily as part of an advertising interface view that is on top of the application interface view. Alternatively, it may be selectively displayed or removed in response to a user's use of certain interface controls. Section 85 of web page 82 corresponds to image 84 and provides a textual description of the advertising interface format, which in this example is “Full Screen Advertising.” Two user input fields are provided in section 85 which allow the application developer to indicate whether full screen advertisements will be allowed and whether video advertisements will be allowed, respectively. In certain examples, the selection of the input fields sets the value of a format flag which may then be used by the computer executable advertising instructions on advertising server 32 to provide advertising content formatted in accordance with the flag values. In addition, computer executable advertising interface instructions on the mobile device 40 may use the format flags to determine how to display advertising content received from advertising server 32. In the example of FIG. 11, the application developer has enabled both full screen advertisements and video. In certain examples, the values of the format flags may be stored in columns 118-124 of table 114 of FIG. 15.

Image 86 depicts a banner ad format with an advertising interface area that comprises a horizontal banner ad at the bottom of display 44. Section 87 corresponds to image 86 and provides a textual description of the advertising format (“Banner Ad”) as well as three input fields. The first input field indicates whether banner advertising is to be allowed. The second input field indicates whether banner advertisements may be displayed at the top of the display, and the third input field indicates whether banner advertisements may be displayed at the bottom of the display (as shown in image 86). Each of the input fields is used to set a format flag used by the computer executable advertising interface instructions on mobile device 40 and/or the computer executable advertising instructions on advertising server 32. In certain examples, the format flag values are stored in columns 118-124 of table 114 of FIG. 15.

Section 89 of web page 82 corresponds to image 88 and provides an advertising interface format in which advertising content is displayed in a corner of mobile device display 44. The advertising interface may also include controls in the region of the advertising content which allow the user to effect desired operations. In one example, the user may select the corner control using a first selection technique to remove advertising from the display 44. In another example, if full screen advertising is enabled, the selection of the corner control using a second selection technique will cause a full screen advertisement to be displayed. Details of the use of advertising corner control interfaces are provided in Applicant's co-pending U.S. patent application Ser. Nos. 13/836,283 and 13/886,811. Section 89 includes five input fields that enable the application developer to select permissible display formats for the corner control. In the example of FIG. 11, the application developer has elected to allow the use of corner advertisements in the bottom left and right hand corners of display 44. The data entered in the input fields may be stored as flag values in columns 118-124 of table 114 of FIG. 15.

Section 92 is provided to allow the application developer to select “notification advertising,” as illustrated in image 90. Certain mobile device operating systems, such as the Android Operating System, provide notification advertisements that comprise moving banners that scroll along the display 44 as shown in image 90 of web page 82. Other notification advertisements may be provided on a pull-down interface that works like a window shade. In section 92 the application developer can use an input field to indicate whether notification advertising is to be enabled. The data entered in the input field may then set the value of a format flag which can be stored in columns 118-124 of FIG. 15.

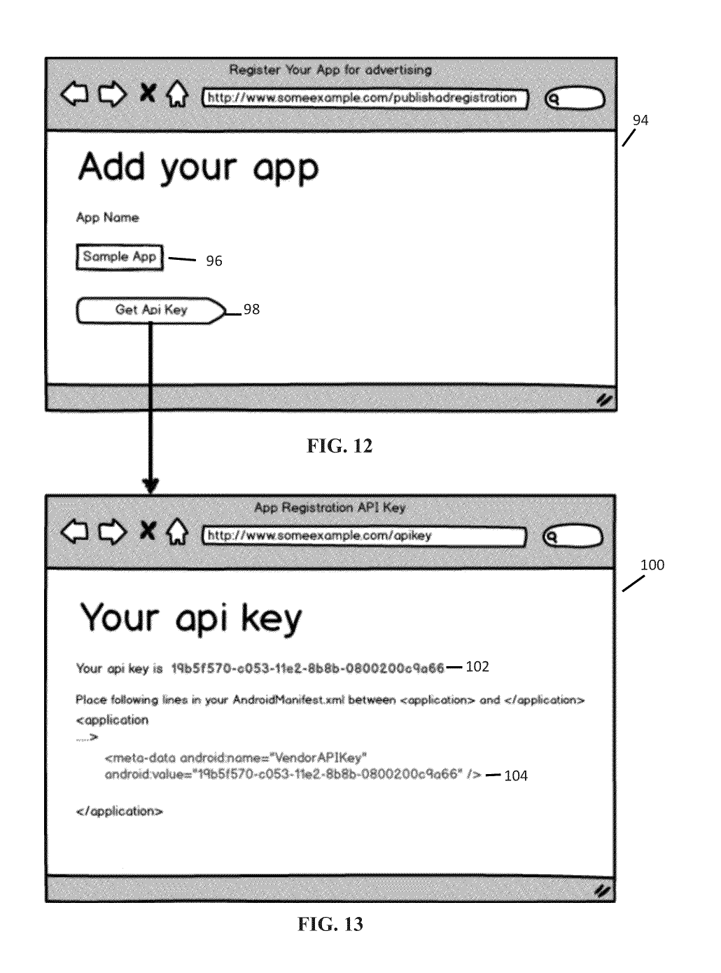

Web pages 94 and 100 (FIGS. 12 and 13) may be provided in those cases where it is necessary to generate new application metadata for use in the method of FIG. 7. As discussed above in connection with FIG. 8, in those embodiments in which the party providing advertising services is also the distributor of the applications on which advertising is provided (e.g., Google and the Google Play Store or Apple and the Apple App Store), the application distributor may receive a form of application metadata generated by the application developer (e.g., a package name, an API key, an encrypted API key) as part of the application distribution process. That application metadata can be used to query the application database 34 and retrieve information from database tables 106 (FIG. 14), 114 (FIG. 15) and 126 (FIG. 16). In those cases, step 1018 of FIG. 7 would be modified because the presence or absence of existing application metadata in the computer executable application instructions would not indicate one way or the other whether that the application is subscribed. In one example, the application metadata would be retrieved from the computer executable application instructions or another file stored on the mobile device 40 and transmitted from mobile device 40 to the advertising server 32. Computer executable advertising instructions executed by the advertising server 32 would then compare the received application metadata to the application database 34 to determine if the application corresponding to the application metadata is subscribed for advertising. If it is not, the advertising server 32 would transmit appropriate data to the mobile device 40 indicating that no advertising is to be provided, and control would transfer to step 1010. If the application were subscribed for advertising, the advertising server 32 would use the application metadata to query the application database 34 and/or advertising content database 35 and transmit the retrieved information to mobile device 40. The computer executable advertising instructions stored on the mobile device 40 would then use the received information from the databases 34 and/or 35 to perform steps 1020 to 1026 as described previously.

Alternatively, the existing application metadata obtained by the application provider can be stored in a specified file location on mobile device 40 to indicate that the application is subscribed for advertising. As indicated above, in some implementations of the systems and methods described herein, the party providing advertising services may also be the party that controls the distribution of applications and may already have application metadata that can be used in steps 1018 and 1020 of FIG. 7 as described previously. However, in some cases, it may nevertheless be convenient to have the application developer add the application metadata to a manifest file (or some other specific file) so that the computer executable advertising interface instructions can use the manifest file to determine whether the application is subscribed for advertising. In one example, the Get API Key 98 on web page 94 may be used to retrieve an existing API key from a set of computer executable application instructions or use an existing API key entered directly into a field on web page 94 and generate the manifest code shown in field 104. The application developer could then add the existing API key to the manifest file using the code in field 104. The computer executable advertising interface instructions stored on the mobile device 40 would then read the manifest file to see if an API key is stored in it. The presence or absence of an API key (or another type of application metadata) in the manifest file could be used to determine if the application is subscribed for advertising. Of course, the type of application metadata that is used must be a type that is not ordinarily stored in the manifest file for another purpose because its presence in the manifest file would not then indicate whether the application is subscribed for advertising.

In other cases in which the advertising services provider does not control the distribution of the application (e.g., if a secondary application is being used to execute computer executable advertising interface instructions), application metadata that can be used in step 1018 of FIG. 7 may not exist or may not exist in a useful format or location. In such cases, new application metadata may need to be generated so that computer executable advertising interface instructions stored on mobile device 40 can perform step 1018 of FIG. 7. In such cases, the presence or lack of application metadata in a specified location (e.g., a specified file) non mobile device 40 would be used by the computer executable advertising interface instructions stored on mobile device 40 to determine whether the application is subscribed for advertising. If the application is subscribed for advertising, step 1020 is performed by transmitting the application metadata to the advertising server 32 so computer executable instructions stored on advertising server 32 can query application database 34 and advertising content database 35 with the application metadata or another database query key that directly corresponds to the application metadata.

In certain implementations requiring the generation of new application metadata, web page 94 (FIG. 12) may be provided. If web page 94 is provided, selection of the “next” button 91 on web page 82 (FIG. 11) takes the user to web page 94 (FIG. 12). On web page 94, the “App Name” field 96 is preferably automatically populated with the name of the application entered into data entry field 72 on web page 70 (FIG. 10). The “Get API Key” button 98 can be selected to execute a set of computer executable application metadata generating instructions that generate application metadata, which in the example of FIGS. 12 and 13 is an API Key. The computer executable application metadata generating instructions may be stored on a computer readable medium that is operatively connected to advertising server 32 and executed by the advertising server 32 CPU. Selection of the Get API Key button 98 causes web page 100 of FIG. 13 to be displayed. Field 102 displays the API Key to the application developer. In field 104 code is displayed for the application developer to enter into a manifest file. In step 1018 of FIG. 7, the computer executable advertising instructions stored on mobile device 40 examine the manifest file to see if application metadata is stored in it. If it is, the application metadata is retrieved from the manifest file and used in step 1020 to query the application database 34 in the manner described previously. Otherwise, step 1018 returns a value of NO, and the method of FIG. 7 ends.

The web pages 70, 82, 94, and 100 are meant to be exemplary only. A number of different display techniques and data input techniques may be used to obtain relevant information about the application and the developer's selection of advertising formats. However, preferred web page interfaces allow the developer to identify the application, chose advertising interface formats, and elect whether to enable advertising for the application being published to application server 30.

The foregoing descriptions of specific embodiments have been presented for purposes of illustration and description. They are not intended to be exhaustive or to limit the invention to the precise forms disclosed. Many modifications and variations are possible in light of the above teachings, with modifications and variations suited to the particular use contemplated.

What is claimed is:

1. A method of displaying advertising on a mobile device, the mobile device having a plurality of applications, a processor, and a display, the method comprising:
identifying an application among the plurality of applications which is executing in the foreground on the mobile device;
determining if advertising has been enabled for the application that is executing in the foreground, and performing the following steps if advertising has been enabled:
receiving advertising content corresponding to the executing application; and
displaying an advertising interface view on the mobile device display on top of an application interface view, wherein the advertising interface view comprises a graphic including the advertising content.

2. The method of claim 1, wherein the step of determining if advertising has been enabled for the application that is executing in the foreground comprises determining if a set of computer executable application instructions corresponding to the application that is executing in the foreground includes application metadata.

3. The method of claim 2, wherein the application metadata comprises an API key.

4. The method of claim 1, wherein the step of determining if advertising has been enabled for the application executing in the foreground comprises querying an application database.

5. The method of claim 4, wherein the application database comprises application metadata and advertising enablement data stored in association with the application metadata, and the application that is executing in the foreground comprises a set of computer executable application instructions that include the application metadata.

6. The method of claim 5, wherein the application metadata comprises an API key.

7. The method of claim 1, wherein the mobile device comprises at least one computer readable storage medium, the application executing in the foreground comprises a set of computer executable application instructions stored on the at least one computer readable storage medium, the step of identifying an application that is executing in the foreground on the mobile device comprises executing a set of computer executable advertising interface instructions stored on the at least one computer readable storage medium, and the set of computer executable advertising interface instructions are stored separately from the computer executable application instructions.

8. The method of claim 1, wherein the advertising interface view comprises an advertising interface control view comprising an advertising control that is user-selectable to remove the advertising interface view from the mobile device display.

9. The method of claim 1, wherein the step of displaying an advertising interface view on the mobile device comprises executing a set of computer executable advertising interface instructions comprising an advertising interface view object.

10. The method of claim 9, wherein the mobile device has at least one computer readable storage medium, the application that is executing in the foreground comprises a set of computer executable application instructions, and the method further comprises storing the advertising interface view object on the at least one computer readable storage medium before storing the computer executable application instructions on the at least one computer readable medium.

11. The method of claim 1, wherein the mobile device comprises at least one computer readable storage medium, the application that is executing in the foreground is a first application comprising computer executable first application instructions stored on the at least one computer readable storage medium, the advertising interface view corresponds to a set of computer executable background application instructions stored on the at least one computer readable medium, and when the application executing in the foreground is executed, the computer executable background application instructions are executed to display the application interface view on the mobile device.

12. The method of claim 11, further comprising downloading the set of computer executable instructions corresponding to the second application from an application server.

13. The method of claim 1, wherein the mobile device includes a mobile device operating system, and the mobile device operating system comprises a set of computer executable steps that display the advertising interface view when executed by the mobile device processor.

14. The method of claim 1, wherein the mobile device includes an operating system having a set of computer executable listener instructions, and the step of identifying an application executing in the foreground comprises executing the set of computer executable listener instructions.

15. The method of claim 1, wherein the mobile device includes a background application comprising a set of computer executable background application instructions, and the step of identifying an executing foreground application comprises executing the computer executable background application instructions to query the applications in the plurality of applications and determine whether any of the applications is executing in the foreground.

16. A method of providing a mobile device for displaying advertising with executing foreground applications, wherein the mobile device includes a display and a processor and the method comprises:
loading a set of computer executable advertising interface instructions on the mobile device, wherein the set of computer executable advertising interface instructions perform the following steps when by the processor:
identifying an executing foreground application from among a plurality of applications loaded on the mobile device;
determining if advertising has been enabled for the executing foreground application;
receiving advertising content corresponding to the executing foreground application if advertising has been enabled for the executing foreground application; and
displaying an advertising interface view including a graphic with the advertising content as a top view on the mobile device display if advertising has been enabled for the executing foreground application.

17. The method of claim 16, wherein the step of loading a set of computer executable advertising interface instructions on the mobile device comprises loading an operating system on the mobile device, and the operating system includes the set of computer executable advertising interface instructions.

18. The method of claim 16, wherein the step of loading a set of computer executable advertising interface instructions on the mobile device comprises downloading a set of computer executable background application instructions corresponding to a background application from an application server, and the set of computer executable application instructions corresponding to the background application includes the set of computer executable advertising interface instructions.

19. The method of claim 16, further comprising loading a set of computer executable application instructions corresponding to the currently executing foreground application on the mobile device.

20. A method of providing advertising on a system of mobile devices, each mobile device having a processor and at least one computer readable storage medium with a set of computer executable advertising interface instructions stored thereon, wherein when executed by the processor, the computer executable advertising interface instructions display an advertising interface view as a top view on a display of a mobile device, the method comprising:
providing a website comprising input fields, wherein the input fields include:
an application metadata input field corresponding to an application;
an advertising enablement input field, wherein the data in the advertising enablement input field determines whether advertising is enabled for the application identified by the application metadata;
storing advertising enablement data from the advertising enablement input field in association with corresponding application metadata from the application metadata input field in an application database on an advertising server;
receiving an application database query from a mobile device, wherein the query includes application metadata for an application executing in the foreground on the mobile device;
transmitting advertising content to the mobile device if the advertising enablement data corresponding to the application metadata for the application executing in the foreground indicates that advertising is enabled for the application executing in the foreground.

21. The method of claim 20, wherein the application metadata comprises an API key.

22. The method of claim 20, wherein each of the mobile devices in the system of mobile devices includes an operating system, and the operating system includes the set of computer executable advertising interface instructions.

23. The method of claim 20, wherein the set of computer executable advertising interface instructions are included in a set of computer executable background application instructions stored on the at least one computer readable storage medium.

24. The method of claim 20, wherein the input fields further include at least one advertising interface format input field, and the method further comprises storing advertising interface format data from the at least one advertising interface format input field in association with corresponding application metadata from the application metadata input field on the advertising server.

25. The method of claim 24, further comprising transmitting advertising interface format data corresponding to the application database query to the mobile device.

26. The method of claim 25, wherein the advertising interface format data corresponds to one selected from the group consisting of a full display advertisement, a banner advertisement, a corner advertisement, and a notification advertisement.

27. A computer readable medium having a set of computer executable advertising interface instructions stored thereon, wherein the computer executable advertising interface instructions are executable by a computer processor to perform the following steps:
identifying an executing foreground application from among a plurality of applications stored on a mobile device having a display;
identifying application metadata for the executing foreground application;
receiving advertising content corresponding to the identified application metadata; and
displaying an advertising interface view comprising the received advertising content on top of an application interface view for the executing foreground application on the mobile device display.

28. The computer readable medium of claim 27, wherein the steps further comprise determining if advertising has been enabled for the executing foreground application.

29. The computer readable medium of claim 27, wherein the set of computer executable advertising interface instructions comprises an advertising interface view object.

30. The computer readable medium of claim 27, wherein the steps further comprise receiving advertising interface format data, and the step of displaying an advertising interface view comprises displaying an advertising interface view having a format corresponding to the advertising interface format data.

31. The computer readable medium of claim 27, wherein the application metadata comprises an API key.

32. A mobile device comprising:
the computer readable storage medium of claim 27;
a processor;
a plurality of applications, each application corresponding to a set of computer executable application instructions stored on the at least one computer readable storage medium; and
a display.

33. The mobile device of claim 32, where the mobile device includes an operating system having a set of computer executable listener instructions stored on the computer readable medium, and when the set of computer executable listener instructions is executed by the processor, executing foreground application identification data is generated, and the set of computer executable advertising interface instructions determine if the set of computer executable application instructions for the application identified by the executing foreground application identification data includes application metadata.

34. The mobile device of claim 32, wherein the mobile device includes a background application comprising a set of computer executable background application instructions stored on the computer readable storage medium, and when the set of computer executable background application instructions is executed by the processor, each application from among the plurality of applications is queried to see if it is executing in the foreground.
